(19) United States
(12) Patent Application Publication
(10) Pub. No.: US 2016/0048662 A1
(43) Pub. Date: Feb. 18, 2016

(54) Computerized CAPTCHA Systems Using A Direct Connection With User Computing Device

(71) Applicant: Google Inc., Mountain View, CA (US)

(72) Inventors: Sacha Christophe Arnoud, San Francisco, CA (US); Angelique Moscicki, Cambridge, MA (US); Edison Tan, Brooklyn, NY (US); David John Abraham, Brooklyn, NY (US); Michael Crawford, Sydney (AU)

(73) Assignee: Google Inc., Mountain View, CA (US)

(21) Appl. No.: 14/187,984

(22) Filed: Feb. 24, 2014

Related U.S. Application Data
(60) Provisional application No. 61/898,579, filed on Nov. 1, 2013.

(51) Int. Cl. G06F 21/31

(52) U.S. Cl. CPC G06F 21/31

(57) ABSTRACT

Computerized CAPTCHA systems using a direct connection with user computing devices are provided. An example computerized CAPTCHA system is configured to perform operations. The operations include receiving a request from a user computing device to engage in a verification process. The request is received independent of a resource provider from which the user computing device has requested a resource. The operations include providing a challenge to the user computing device at least in part in response to the request for engagement in the verification process and receiving a response to the challenge from the user computing device. The operations include determining whether the user computing device should be verified based at least in part on the response and providing a verification token to the user computing device when it is determined that the user computing device should be verified.

### CROSS-REFERENCE TO RELATED APPLICATION

The present application is based on and claims priority to U.S. Provisional Application 61/898,579 having a filing date of Nov. 1, 2013, which is incorporated by reference herein.

### FIELD

The present disclosure is generally directed to CAPTCHA systems. More particularly, the present disclosure is directed to computerized CAPTCHA systems which utilize a direct connection with a user computing device.

### BACKGROUND

Trust is an asset in web-based interactions. For example, a user must trust that an entity provides sufficient mechanisms to confirm and protect her identity or other confidential information in order for the user to feel comfortable interacting with such entity. Further, an entity that provides a web-resource must be able to block automated attacks that attempt to gain access to the web-resource for malicious purposes. Thus, sophisticated authentication mechanisms that can discern between a resource request originating from a human being and a request generated by an automated machine are a vital tool in ensuring that web-resources are protected from automated attacks and developing the necessary relationship of trust between a resource provider and a user.

CAPTCHA systems (“completely automated public Turing test to tell computers and humans apart”) can provide such an authentication mechanism. One goal of a CAPTCHA system is to exploit situations in which it is known that humans perform tasks better than automated machines. Thus, as part of a verification process, CAPTCHA systems can provide a CAPTCHA challenge that is solvable by a human but generally unsolvable by a machine.

One problem associated with existing CAPTCHA system configurations is that the verification process relies solely on the passive complexity of the CAPTCHA challenge. For example, for configurations in which an image challenge is simply fetched from the CAPTCHA system, the verification process relies solely on the difficulty of solving the image challenge. Thus, the verification process is not dynamically tuned or otherwise intelligently tailored in light of any additional available information.

In addition, from the perspective of the user, another problem associated with existing system configurations is that the user must interact with the resource provider as a supervisor of the verification process. For example, certain verification processes can include the submission of identifying information, such as a user account, in addition to solving a CAPTCHA challenge. In certain situations, the user may prefer to interact directly with a CAPTCHA system that is provided by a known, trusted entity rather than submit identifying information to a yet unknown or untrusted resource provider.

### SUMMARY

Aspects and advantages of embodiments of the present disclosure will be set forth in part in the following description, or may be obvious from the description, or may be learned through practice of the embodiments.

One aspect of the present disclosure is directed to a computerized CAPTCHA system configured to perform operations. The operations include receiving, by one or more computing devices, a request from a user computing device to engage in a verification process. The request is received independent of a resource provider from which the user computing device has requested a resource. The operations include providing, by the one or more computing devices, a challenge to the user computing device at least in part in response to the request for engagement in the verification process. The operations include receiving, by the one or more computing devices, a response to the challenge from the user computing device. The operations include determining, by the one or more computing devices, whether the user computing device should be verified based at least in part on the response. The operations include providing, by the one or more computing devices, a verification token to the user computing device when it is determined that the user computing device should be verified.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

A detailed discussion of embodiments of the present disclosure directed to one of ordinary skill in the art is set forth in the specification, which makes reference to the appended figures, in which:

FIG. 1 depicts an example system for verifying a user computing device according to an example embodiment of the present disclosure;

FIG. 2 depicts a flow chart of an example method for verifying a user computing device according to an example embodiment of the present disclosure;

FIG. 3 depicts a flow chart of an example method for operating a user computing device according to an example embodiment of the present disclosure;

FIG. 4 depicts an example user interface according to an example embodiment of the present disclosure; and

FIGS. 5A and 5B depict a flow chart of an example method for operating a computerized CAPTCHA system according to an example embodiment of the present disclosure.

### DETAILED DESCRIPTION

Reference now will be made in detail to embodiments of the present disclosure, one or more examples of which are illustrated in the drawings. Each example is provided by way of explanation of embodiments, not limitation of the present disclosure. In fact, it will be apparent to those skilled in the art that various modifications and variations can be made to embodiments without departing from the scope or spirit of the present disclosure. For instance, features illustrated or described as part of one embodiment can be used with another embodiment to yield a still further embodiment.

Generally, the present disclosure is directed to a system and method in which a user computing device interfaces directly with a computerized CAPTCHA system in order to gain access to a resource from a resource provider. As an example, a user can attempt to bid in an online auction using her smartphone. In order to access the bidding interface and place the bid, the user can first be required to directly interact with a computerized CAPTCHA system and verify her human status, thereby preventing “bots” from damaging the bidding process.

By contrast, in certain existing CAPTCHA system configurations, the resource provider serves as an intermediary between the user computing device and the CAPTCHA system. As an example, the user computing device can request access to a resource from a resource provider, for example via a webpage of the resource provider. As a result, in such existing configurations, the resource provider can return a webpage or other computer-readable code that instructs the user computing device to retrieve a simple CAPTCHA challenge from a CAPTCHA system, for example by fetching an image of distorted text from the CAPTCHA system. Alternatively, the resource provider can fetch the image from the CAPTCHA system and then provide the image to the user computing device.

In such certain existing CAPTCHA system configurations, after receiving the challenge, the user computing device can obtain a solution from the user and return it to the resource provider, for example via a form on the resource provider website. In turn, the resource provider can communicate with the CAPTCHA system to confirm whether the user-provided solution is correct. Thus, in such configurations, the resource provider is responsible for supervising the verification process and is required to handle or forward several sets of data.

However, several problems are associated with such existing configurations. As an example, because the resource provider is required to serve as an intermediary between the user computing device and the CAPTCHA system, each instance of communication can suffer from increased latency, thereby increasing the delay between requesting and accessing the resource and reducing user satisfaction.

Another problem associated with existing configurations is that the resource provider must maintain sufficient computing resources and security procedures to implement and supervise the verification process. In particular, in such existing configurations, the resource provider can be required to update their system or computing capabilities in order to accommodate new challenge formats, such as, for example, audio CAPTCHA challenges for the visually impaired.

Thus, in such existing configurations, each improvement or update to the verification process can require corresponding updates or enhanced computing resources implemented by the resource provider. As automated attacks generally increase in sophistication and intelligence over time, new verification techniques will be required, placing a strain on the resource provider to continually update their system and ensure that they are not a vulnerable link in the verification process. For many resource providers, such continual updates can represent a drain of computing or engineering resources and a distraction from otherwise improving aspects of their core product or service.

Thus, the present disclosure provides a solution to many of these problems by using a direct connection between the user computing device and the computerized CAPTCHA system in order to gain access to a resource from a resource provider.

In particular, according to the present disclosure, in response to a request for access to a resource, a resource provider can instruct a user computing device to directly connect to a computerized CAPTCHA system. As an example, for the user attempting to bid in an online auction using her smartphone, the auction website can redirect a browser on the user's smartphone so that it directly connects with the computerized CAPTCHA system and begins the verification process. As another example, the smartphone can directly connect to the computerized CAPTCHA system by executing a user client-side script included in an inline frame or embedded widget included in the auction website. For example, by executing the user computing-side script, the smartphone can transmit a request to the computerized CAPTCHA system that is formatted according to an application programming interface associated with the computerized CAPTCHA system.

In some embodiments of the present disclosure, in order to obtain the benefits of the techniques described herein, the user may have to allow the use of additional information associated with the user or her smartphone by the computerized CAPTCHA system. If the user does not allow use of such additional information, then the user may not receive the benefits of the techniques described herein.

For example, in various embodiments, the additional information may include one or more of, for example, a device type, one or more device computing capabilities, an Internet Protocol address, a user web-history, whether the user participates in various other web-services, or other additional information.

In some embodiments in which the systems and method discussed herein utilize information about users or user computing devices, such as device type, device location, user participation in web-services, or other information, the users may be provided with an opportunity to control whether programs or features collect or utilize such information. In addition, in various embodiments, certain information or data can be treated in one or more ways before it is stored or used, so that it is not personally identifiable.

Based on such additional information, the computerized CAPTCHA system can dynamically tune or adjust various attributes of the verification process, including a challenge type, a challenge difficulty, a challenge format, or other suitable variables. As an example, if the computerized CAPTCHA system recognizes that the user is interacting through a mobile device (e.g. her smartphone), then a challenge included in the verification process can be of the appropriate size and style for solving using a mobile device. As another example, if the computerized CAPTCHA system learns that the user computing device is compatible with only certain programming platforms or file formats, then the computerized CAPTCHA system can ensure that the challenge provided to the user computing device complies with such device capabilities or constraints.

In such fashion, additional information obtained as a result of a direct interaction between the user computing device and the computerized CAPTCHA system can be used to provide an intelligently tailored verification process. Furthermore, because the user is interacting directly with the computerized CAPTCHA system, the user can be confident that her information is being handled in a more secure fashion, rather than being passed back and forth between the resource provider and an unseen computerized CAPTCHA system.

In particular, once the computerized CAPTCHA system has been sufficiently convinced that the user computing device is operated by a human, the computerized CAPTCHA system can provide a verification token or certificate to the user computing device. The user computing device can then provide the verification token to the resource provider. In turn, the resource provider can confirm the validity of the verification token with the computerized CAPTCHA system. Upon confirmation of token validity, the resource provider can provide the resource to the user computing device.

As an example, after the user successfully completes a challenge, the computerized CAPTCHA system can send a verification token to the user's smartphone. The user's smartphone can present the token to the auction website, which can, in turn, confirm the validity of the token with the computerized CAPTCHA system.

In such fashion, problems associated with implementation of the verification process by the resource provider can be reduced or eliminated. As an example, the auction website is not required to support multiple challenge formats or update their system each time the verification process is updated or improved. Instead, the auction website can simply rely upon the computerized CAPTCHA system to perform the entirety of the verification process and validate the resulting verification token provided by the user computing device.

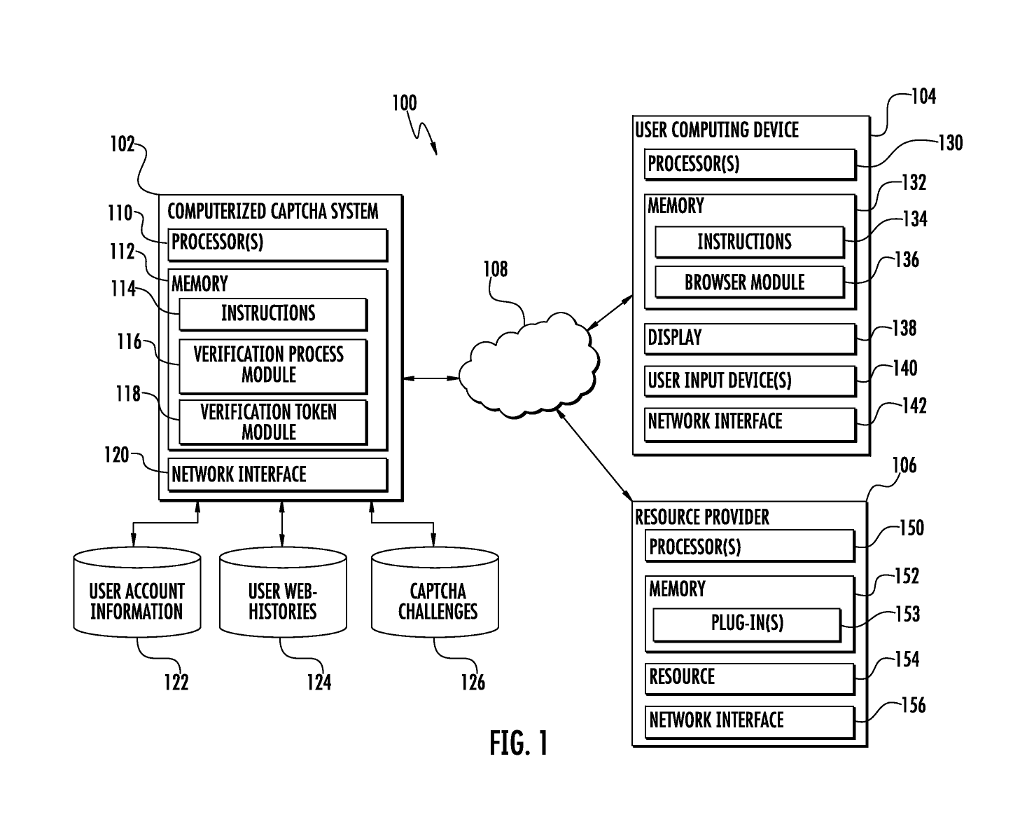

Referring now to the FIGS., example embodiments of the present disclosure will be discussed in further detail. FIG. 1 depicts an example system 100 for verifying a user computing device 104 according to an example embodiment of the present disclosure. In particular, system 100 can include a computerized CAPTCHA system 102, a user computing device 104, and a resource provider 106 in communication with each other over a network 108.

Computerized CAPTCHA system 102 can be implemented using one or more computing devices, such as, for example, one or more servers. In particular, any computing tasks performed by computerized CAPTCHA system 102 can be performed by any combination of one or more computing devices connected in a parallel or distributed computing system. Computerized CAPTCHA system 102 can include one or more processors 110 and a memory 112. Processor 110 can be any suitable processing device and can be one processor or a plurality of processors which are operably connected. Memory 112 can store instructions 114 that cause processor 110 to perform operations to implement the present disclosure.

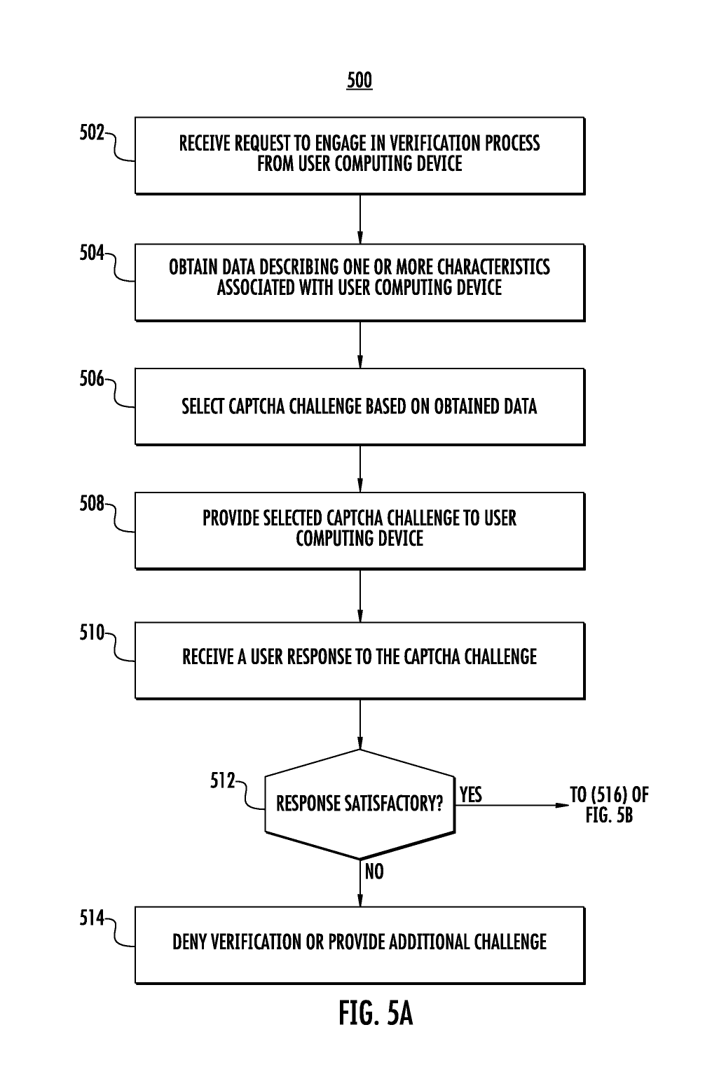

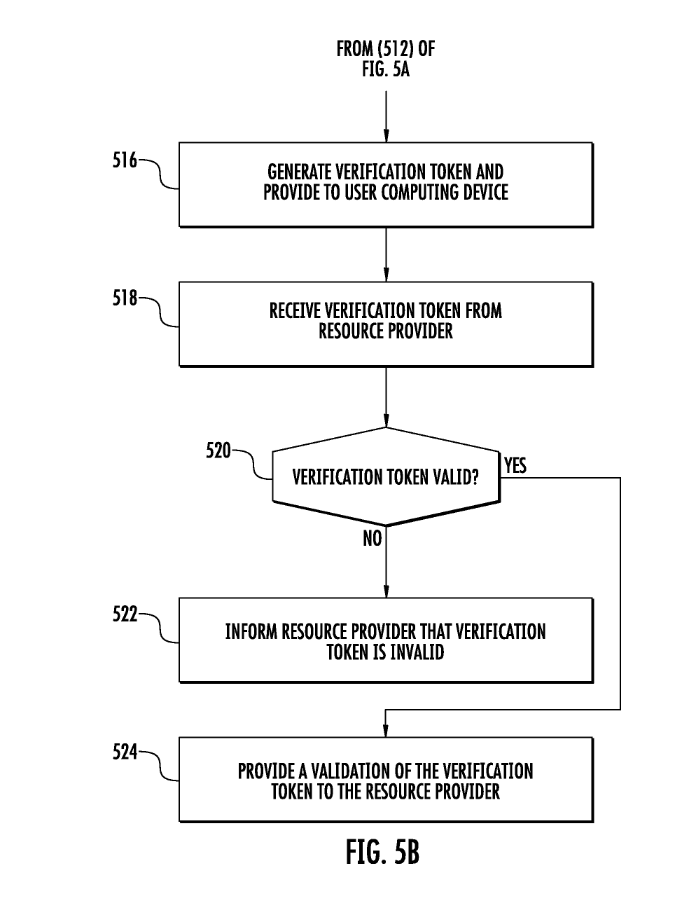

Memory 112 can also include a number of modules, including, for example, verification process module 116 and verification token module 118. Computerized CAPTCHA system 102 can implement verification process module 116 to perform various aspects of a verification process. For example, verification process module 116 can be implemented to receive a request to engage in a verification process from user computing device 104, select and provide a CAPTCHA challenge to user computing device 104, and determine whether a received response satisfies the provided challenge. In some implementations, verification process module 116 can be implemented to perform aspects of method (500) of FIGS. 5A and 5B.

Computerized CAPTCHA system 102 can implement verification token module 118 to generate and validate verification tokens for any number of user computing devices 104 and resource providers 106. For example, verification token module 118 can be implemented to generate and provide a verification token to user computing device 104 and receive and validate a verification token for resource provider 106. In some implementations, verification token module 118 can be implemented to perform aspects of method (500) of FIGS. 5A and 5B.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, hard disk or optical or magnetic media. When software is used, any suitable programming language or platform can be used to implement the module.

Furthermore, while verification process module 116 and verification token module 118 are depicted in FIG. 1 as separate modules or components of computerized CAPTCHA system 102, in some implementations such modules can be combined to form a single module or distributed to form several additional modules.

Computerized CAPTCHA system 102 can also include a network interface 120 for communicating over network 108. Network interface 120 can include any suitable components for interfacing with one more networks, including for example, transmitters, receivers, ports, controllers, antennas, or other suitable components.

Computerized CAPTCHA system 102 can include or otherwise be in communication with any number of databases, including, for example, a user account database 122, a user web-history database 124, and a CAPTCHA challenges database 126. It will be appreciated that database or other data storage functionality can be implemented using a single database or can be distributed across a plurality of storage devices. Further, each of such databases 122, 124, and 126 can be located locally or located remotely and accessed over a network.

User account database 122 can store or provide data associated with a plurality of user accounts. For example, a user account can be any account or means of identification that is associated with a user of a service. Example user accounts include an operating system account; an account used for purchasing and ownership of content from a content distribution platform; a web-based email account; a social media account; a game account; an application-specific account; or any other suitable user account.

Computerized CAPTCHA system 102 can access user account database 122 to determine whether user computing device 104 is associated with a known user account. As an example, in some implementations, computerized CAPTCHA system 102 is associated with a service provider that offers several of the services discussed above (e.g. web-based email, social media, gaming, and content distribution) and a single user account can be used to participate in, receive, or otherwise control aspects of each of such services.

Thus, in some implementations, the verification process by which computerized CAPTCHA system 102 verifies user computing device 104 can include receiving or otherwise identifying user account information associated with user computing device 104 and cross-referencing such information against user account information 122. In particular, ownership and maintenance of a valid, reputable user account can represent a significant investment of time and computing resources on the part of a user and, therefore, can provide a strong indication that the user computing device 104 is operated by a human being and is not an automated bot. In such fashion, preexisting information associated with the user computing device, such as, for example, user account information, can be leveraged to provide enhanced verification of a user computing device 104.

In some embodiments in which the systems and method discussed herein utilize information about users or user computing devices, such as user account information, the users may be provided with an opportunity to control whether programs or features collect or utilize such information. In addition, in various embodiments, certain information or data can be treated in one or more ways before it is stored or used, so that it is not personally identifiable.

User web-history database 124 can store or provide data describing previous web activity or web interactions performed by one or more computing devices associated with a user account. For example, user web-history database 124 can indicate whether a user account has a history of normal, reputable web-usage or whether the user account has been linked to abusive or malicious web-behavior. Thus, in some implementations, the verification process can include accessing a user web-history associated with user computing device 104 from database 124 and analyzing whether such web-history is indicative of a human being or an automated bot.

In some embodiments in which the systems and method discussed herein utilize information about users or user computing devices, such as a user web-history, the users may be provided with an opportunity to control whether programs or features collect or utilize such information. In addition, in various embodiments, certain information or data can be treated in one or more ways before it is stored or used, so that it is not personally identifiable.

CAPTCHA challenges database 126 can provide a plurality of different CAPTCHA challenges from which computerized CAPTCHA system 102 can select. For example, the challenges included in database 126 can be of varying size, shape, format, difficulty, programming language, or other variable parameters. For example, available challenge formats can include an image challenge featuring scrambled, blurred, or otherwise distorted text that must be interpreted or decoded, an audio challenge featuring distorted audio that must be interpreted, a visual matching challenge, a visual selection challenge, or other suitable challenge formats. Generally, one or more solutions to each challenge can be stored in challenge database 126 as well.

As an example, in some implementations, CAPTCHA challenges included in database 126 can include challenges optimized for mobile user computing devices, such as smartphones. For example, the challenges for mobile devices can require the user to utilize a touch-sensitive screen of the mobile device to draw a shape, trace an outline, press or select one option out of several options provided, solve a maze, or other challenges which require use of the touch-sensitive screen. In such fashion, users of a mobile user computing device 104 can be provided with an optimized challenge that, for example, does not require use of a keyboard.

User computing device 104 can be a computing device having a processor 130 and a memory 132. As example, user computing device 104 can be a wireless mobile device, a personal digital assistant (PDA), smartphone, tablet, laptop computer, desktop computer, computing-enabled watch, computing-enabled eyeglasses, a wearable computing device, embedded computing system, home appliances, or any other computing device.

Processor 130 of user computing device 104 can be any suitable processing device and can be one processor or a plurality of processors that are operably connected. Memory 132 can include any number of computer-readable instructions 134 or other stored data. For example, memory 132 can include, store, or provide a browser module 136. When implemented by processor 130, browser module 136 can cause or instruct processor 130 to run a web browser application.

It will be appreciated that user computing device 104 can further include any number of other application modules to perform any number of applications to provide additional functionality. In addition, instructions 134 can provide functionality for performing operations according to various programming languages, platforms, layers, or communications techniques. For example, user computing device 104 can include one or more engines for interpreting and executing various programming languages, such as, for example, a JavaScript engine.

User computing device 104 can include or be in communication with a display 138 for displaying information to the user. Further, user computing device 104 can include any number of user input devices 140, such as, for example, a keyboard, a mouse, a microphone, a touch-sensitive screen, motion sensors, a touch-pad, a keyboard stick, buttons, or other suitable controls.

User computing device 104 can further include a network interface 142. Network interface 142 can include any suitable components for interfacing with one more networks, including for example, transmitters, receivers, ports, controllers, antennas, or other suitable components.

Generally, resource provider 106 can be implemented using a server or other computing device. Resource provider 106 can include one or more processors 150 and other suitable components such as a memory 152 and a network interface 156. Processor 150 can implement computer-executable instructions stored on the memory 152 in order to perform desired operations.

Resource provider 106 can provide access to a resource 154 over the network 108. Non-limiting examples of resources 154 include a cloud-based email client, a social media account or content, software as a service, an online auction interface, a financial services account, an online game, a data library, a code library, an arbitrary web-service, or any other suitable resource.

Furthermore, according to an aspect of the present disclosure, memory 152 of resource provider 106 can include one or more plug-ins 153. In particular, resource provider 106 can obtain plug-in 153 from computerized CAPTCHA system 102 or an entity that provides system 102.

As an example, plug-in 153 can include computer-readable instructions and a library so that resource provider 106 can communicate with computerized CAPTCHA system 102 using an application programming interface associated with computerized CAPTCHA system 102. For example, plug-in 153 can be formatted according to any suitable programming environment, including, for example, PHP, ASP.NET, Classic ASP, Java/JSP, Perl, Python, Ruby, Ruby/Rack, ColdFusion, WebDNA, VBScript, or other programming environments.

As another example, plug-in 153 can include computer-readable instructions designed to be embedded within the website of resource provider 106, served by resource provider 106 to user computing device 104, and then executed by user computing device 104. For example, plug-in 153 can include instructions designed to be embedded within any suitable website or application, including, for example, WordPress, MediaWiki, phpBB, FormMail, Movable Type, Drupal, Symfony, TYPA3, NucleusCMS, vBulletin, Joomla, bbPress, ExpressionEngine, FlatPress, PHPKIT, or other applications.

More particularly, plug-in 153 can provide a client-side script to be included within an inline frame, embedded object, portlet, or other embedded application or widget included in the website of resource provider 106. The client-side script can be formatted according to any suitable programming language including, for example, Javascript, Ajax, jQuery, ActionScript, or other programming languages.

User computing device 104 can execute the embedded client-side script to directly engage with computerized CAPTCHA system 102. In particular, use of such client-side script can ensure that communications from user computing device 104 to computerized CAPTCHA system 102 are formatted according to the application programming interface associated with computerized CAPTCHA system 102. In such fashion, resource provider 106 can instruct user computing device 104 to communicate directly with computerized CAPTCHA system 102.

Furthermore, in some implementations, resource provider 106 can store one or more public and/or private keys in memory 152. The public and private keys can have been provided to resource provider 106 by computerized CAPTCHA system 102 and can be used to identify resource provider 106 to computerized CAPTCHA system 102.

As an example, resource provider 106 can provide the public key to a user computing device 104 attempting to access resource 154. The user computing device 104 can provide the public key to computerized CAPTCHA system 102 so that computerized CAPTCHA system 102 is aware of which resource provider 106 the user computing device 104 is attempting to access. As another example, resource provider 106 can provide the private key to computerized CAPTCHA system 102 in its communications with computerized CAPTCHA system 102 so that computerized CAPTCHA system 102 recognizes and identifies resource provider 106 as a known resource provider with which to communicate.

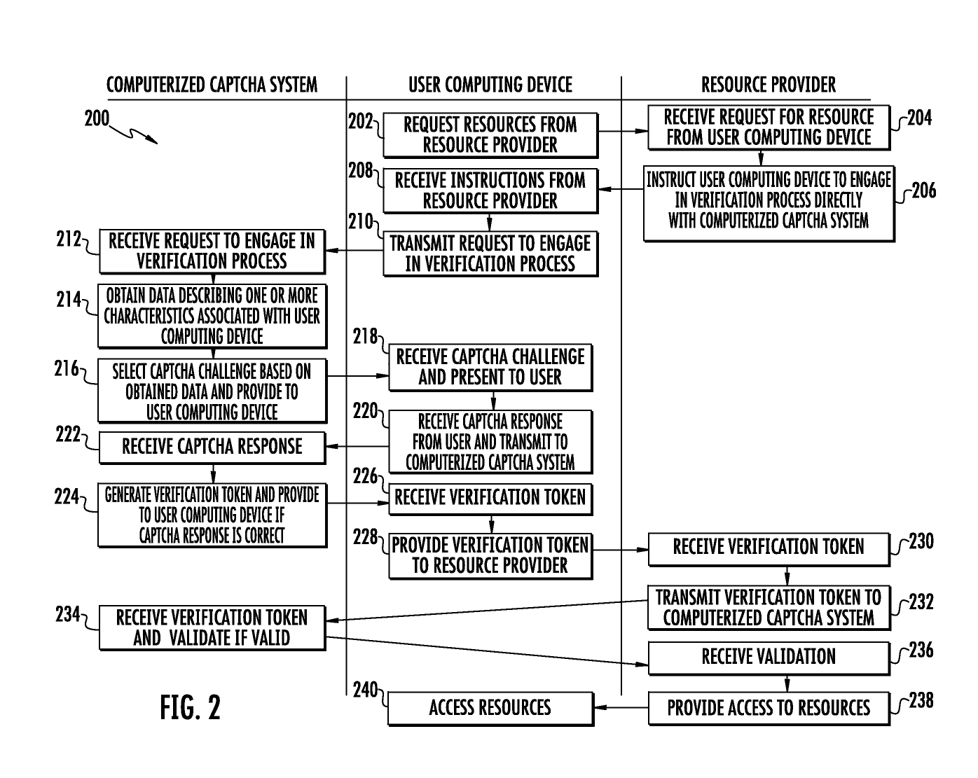

FIG. 2 depicts a flow chart of an example method (200) for verifying a user computing device according to an example embodiment of the present disclosure. Method (200) can be implemented using any suitable computing system, including, for example, example system 100 of FIG. 1.

In addition, although FIG. 2 depicts steps performed in a particular order for purposes of illustration and discussion, methods of the present disclosure are not limited to such particular order or arrangement. One skilled in the art, using the disclosures provided herein, will appreciate that various steps of the method (200) can be omitted, rearranged, combined, and/or adapted in various ways without deviating from the scope of the present disclosure.

At (202) a user computing device can request a resource from a resource provider. At (204) the resource provider can receive the request for the resource from the user computing device.

At (206) the resource provider can instruct the user computing device to engage in a verification process directly with a computerized CAPTCHA system. At (208) the user computing device can receive the instructions from the resource provider to directly engage with the computerized CAPTCHA system. As an example, the resource provider can instruct the user computing device at (206) by redirecting a browser of the user computing device so that it directly connects with the computerized CAPTCHA system and begins the verification process.

As another example, at (206) the resource provider can provide the user computing device with a client-side script that, when executed by the user computing device, causes the user computing device to directly engage with the computerized CAPTCHA system. For example, the client-side script can be included in an inline frame, embedded object, portlet, or other embedded application or widget. In some implementations, the client-side script can be included in a plug-in provided from the computerized CAPTCHA system to the resource provider. Furthermore, in some implementations, at (206) the resource provider can provide the user computing device with a public key identifying the resource provider to the computerized CAPTCHA system.

At (210) the user computing device can transmit a request directly to the computerized CAPTCHA system to engage in a verification process. At (212) the computerized CAPTCHA system can receive the request from the user computing device.

As an example, the request transmitted at (210) can be formatted according to an application programming interface associated with the computerized CAPTCHA system. For example, the request can be transmitted as a result of executing a client-side script provided to the user computing device at (206). Furthermore, in some implementations, the request transmitted at (210) can include a public key associated with the resource provider.

At (214) the computerized CAPTCHA system can obtain data describing one or more characteristics associated with the user computing device. As examples, the one or more characteristics can include a device type, one or more device capabilities, an Internet Protocol address, user account information, a user web-history, whether the user participates in various other web-services, or other information.

For example, obtaining data at (214) that describes device capabilities can include determining whether the user computing device is a mobile device, identifying various programming platforms with which the user computing device is compatible, determining whether the user computing device includes a touch-sensitive input device, determining a size or a shape of a display of the user computing device, or determining other user computing device operational parameters or operational constraints.

Thus, in some implementations, obtaining at (214) data describing one or more characteristics associated with the user computing device at (214) can include receiving or otherwise identifying user account information associated with the user computing device and cross-referencing such information against a database of user account information and/or a database of user web-histories to determine the validity and reputation of the provided user account.

At (216) the computerized CAPTCHA system can select a CAPTCHA challenge based on the data obtained at (214) and provide the selected challenge to the user computing device. For example, the computerized CAPTCHA system can include a database of CAPTCHA challenges having varying formats, difficulties, shapes, sizes, file format, programming language, or other variable parameters. At (216) the computerized CAPTCHA system can select a CAPTCHA challenge from the database based on the data obtained at (214).

As an example, in the instance that the data obtained at (214) indicates that the user computing device is a mobile device, such as, for example, a smartphone, then at (216) the computerized CAPTCHA system can select a CAPTCHA challenge designed for a mobile device. For example, challenges designed for mobile devices can require the user to utilize a touch-sensitive screen of the mobile device to draw a shape, trace an outline, press or select one option out of several options provided, solve a maze, or other challenges which require use of the touch-sensitive screen.

As another example, in the instance that the data obtained at (214) includes a size and shape of the display of the user computing device, then at (216) the computerized CAPTCHA system can select a CAPTCHA challenge formatted for that size and shape. As yet another example, in the instance that the data obtained at (214) indicates that the user computing device is compatible with a particular programming platform or file format, but not with others, then at (216) the computerized CAPTCHA system can select a CAPTCHA challenge with which the user computing device will be compatible.

As another example, in the instance that the data obtained at (214) indicates that the user is visually impaired or physically impaired, then at (216) the computerized CAPTCHA system can select a CAPTCHA challenge that has an audio prompt and/or can be solved without physical activity (e.g. speaking the solution into a microphone). As yet another example, if the data obtained at (214) indicates a relative reputation or trustworthiness of the user computing device, for example by identifying a user account and associated web-history, then at (216) the computerized CAPTCHA system can select a CAPTCHA challenge having a difficulty corresponding to the indicated trustworthiness. For example, a user computing device with zero or negative reputation can be provided with a more difficult challenge while a user computing device having a positive reputation can be provided with an easier challenge or more attempts to solve the challenge.

At (218) the user computing device can receive the CAPTCHA challenge from the computerized CAPTCHA system and present it to the user, for example, on a display of the user computing device. At (220) the user computing device can receive a response from the user and transmit it to the computerized CAPTCHA system. At (222) the computerized CAPTCHA system can receive the response from the user computing device.

If the response received at (222) is correct or otherwise satisfies the CAPTCHA challenge, then at (224) the computerized CAPTCHA system can generate a verification token and provide it to the user computing device. At (226) the user computing device can receive the verification token from the computerized CAPTCHA system.

As an example, the verification token can be an authentication certificate or other security or authentication device or mechanism. For example, in some implementations, the verification token can include a hash of a user computing device identifier or other information or can incorporate the resource provider's public key.

It will be appreciated that, in some implementations, steps (210)-(226) can be considered a verification process. Further, in some implementations, steps (210)-(226) can occur via an inline frame, embedded object, portlet, or other embedded widget or application included in the resource provider's website.

At (228) the user computing device can provide the verification token to the resource provider. At (230) the resource provider can receive the verification token from the user computing device.

At (232) the resource provider can transmit the verification token to the computerized CAPTCHA system. In some implementations, at (232) the resource provider can also transmit its private key to the computerized CAPTCHA system together with the verification token.

At (234) the computerized CAPTCHA system can provide a validation of the verification token to the resource provider if the verification token is valid. If the verification token is invalid or has been tampered with, then the computerized CAPTCHA system can inform the resource provider that the verification token is invalid.

At (236) the resource provider can receive the validation of the verification token from the computerized CAPTCHA system. In response to receiving the validation at (236), at (238) the resource provider can provide the user computing device with access to the resource. At (240) the user computing device can access the resource.

In such fashion, the user or user computing device can be verified by engaging in a verification process directly with the computerized CAPTCHA system. Therefore, problems associated with implementation of the verification process by the resource provider can be reduced or eliminated. As an example, the resource provider is not required to support multiple challenge formats or update their system each time the verification process is updated or improved. Instead, the resource provider can simply rely upon the computerized CAPTCHA system to perform the entirety of the verification process and validate the resulting verification token provided by the user computing device.

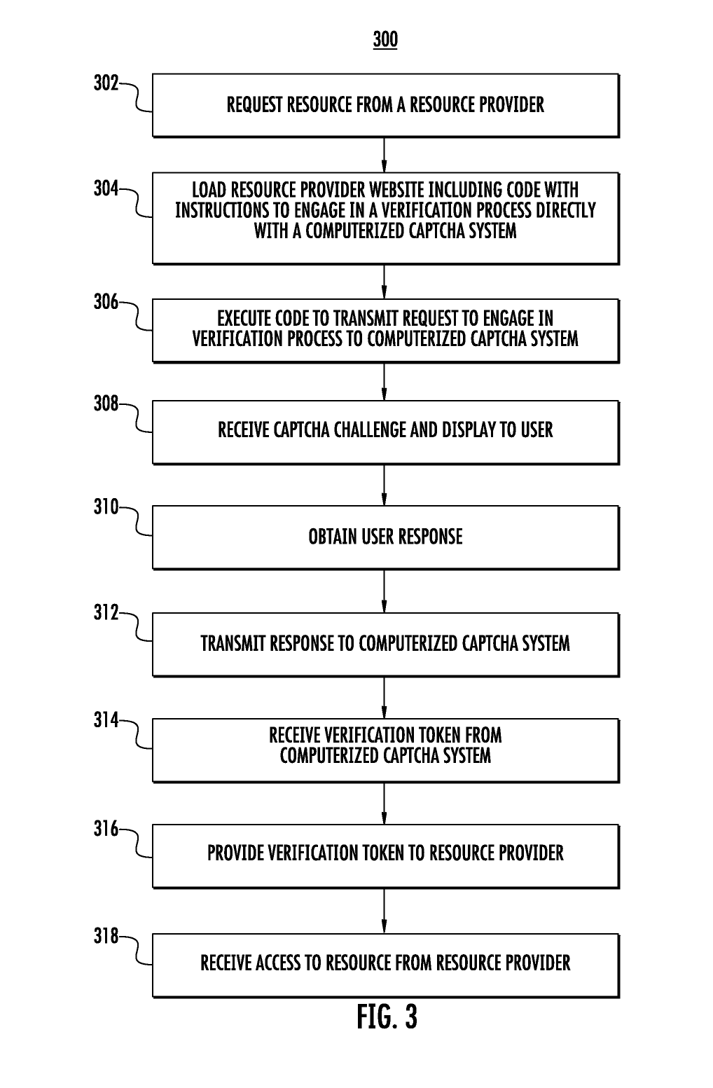

FIG. 3 depicts a flow chart of an example method (300) for operating a user computing device according to an example embodiment of the present disclosure. Method (300) can be implemented by any suitable user computing device, including user computing device 104 of FIG. 1.

In addition, although FIG. 3 depicts steps performed in a particular order for purposes of illustration and discussion, methods of the present disclosure are not limited to such particular order or arrangement. One skilled in the art, using the disclosures provided herein, will appreciate that various steps of the method (300) can be omitted, rearranged, combined, and/or adapted in various ways without deviating from the scope of the present disclosure.

At (302) the user computing device can request a resource from a resource provider. For example, a user can operate her smartphone to request an online auction website for access to a bidding interface.

At (304) the user computing device can load a website of the resource provider. In particular, the resource provider website can include computer-readable code that includes instructions to engage in a verification process directly with a computerized CAPTCHA system.

For example, in response to the request to access the bidding interface, the auction website can return a website that includes an embedded object containing a client-side script that, when executed by the user computing device, causes the user computing device to engage directly with the computerized CAPTCHA system.

At (306) the user computing device can execute the computer-readable code received at (304), thereby transmitting to the computerized CAPTCHA system a request to engage in the verification process.

At (308) the user computing device can receive a CAPTCHA challenge from the computerized CAPTCHA system and display it to the user. As an example, the smartphone can receive a CAPTCHA challenge and present it to the user on the smartphone display.

At (310) the user computing device can receive a response from the user. For example, the user can use a physical or virtual keyboard to input a response into a text field provided by the smartphone.

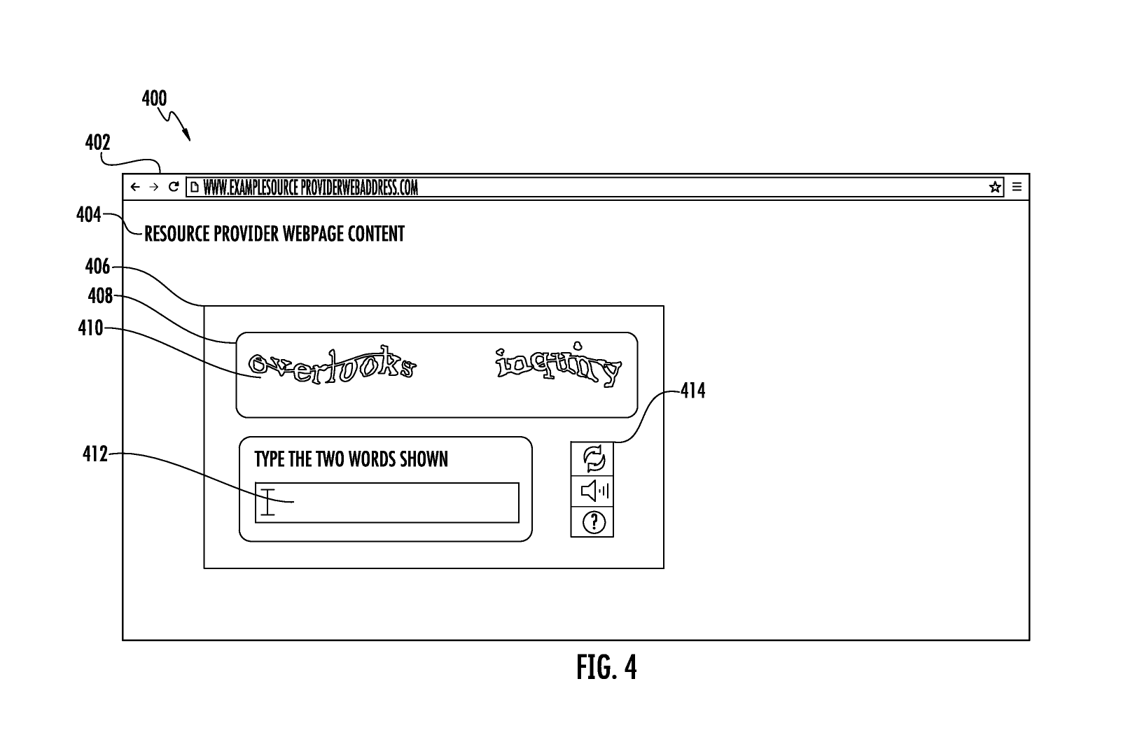

As an example, FIG. 4 depicts an example user interface 400 according to an example embodiment of the present disclosure. In particular, user interface 400 is provided within a browser window 402 of the user computing device.

User interface 400 can include content 404 provided by the resource provider. In addition, user interface 400 can include an inline frame 406. Inline frame 408 can serve as a portal for the user computing device to communicate directly with a computerized CAPTCHA system.

Inline frame 408 can provide a challenge prompt area 408, a challenge response field 412, and a control panel 414. Displayed within challenge prompt area 408 can be a CAPTCHA challenge prompt 410.

Challenge response field 412 can provide an opportunity for the user to input text as a response to the challenge. Control panel 414 can include various controls for interacting with the computerized CAPTCHA challenge system, including, for example, a control to receive a new challenge, a control to receive an audio challenge, and a help or information button.

Returning to FIG. 3, at (312) the user computing device can transmit the response obtained at (310) to the computerized CAPTCHA system. At (314) the user computing device can receive a verification token from the computerized CAPTCHA system.

At (316) the user computing device can provide the verification token to the resource provider. At (318) the user computing device can receive access to the resource from the resource provider.

For example, the auction website can permit the smartphone to access the bidding interface and allow the user to bid in an online auction. In such fashion, the user and her smartphone can be verified prior to allowing the user to participate in the online auction, thereby preventing automated bots from damaging the auction process.

FIGS. 5A and 5B depict a flow chart of an example method (500) for operating a computerized CAPTCHA system according to an example embodiment of the present disclosure. Method (500) can be implemented by any suitable computerized CAPTCHA system, including computerized CAPTCHA system 102 of FIG. 1.

In addition, although FIGS. 5A and 5B depict steps performed in a particular order for purposes of illustration and discussion, methods of the present disclosure are not limited to such particular order or arrangement. One skilled in the art, using the disclosures provided herein, will appreciate that various steps of the method (500) can be omitted, rearranged, combined, and/or adapted in various ways without deviating from the scope of the present disclosure.

Referring to FIG. 5A, at (502) the computerized CAPTCHA system can receive a request to engage in a verification process from a user computing device. For example, a user attempting to access a bidding interface via her smartphone can be redirected to interface directly with the computerized CAPTCHA system.

Further, in some embodiments, a public key can be received from the user computing device at (502). For example, the public key can identify the auction website with which the user is attempting to interact.

At (504) the computerized CAPTCHA system can obtain data describing one or more characteristics associated with the user computing device. For example, at (504) the computerized CAPTCHA system determine that the smartphone is a mobile device and is associated with a reputable user account.

At (506) the computerized CAPTCHA system can select a CAPTCHA challenge based at least in part on the data obtained at (504). For example, the computerized CAPTCHA system can select a challenge designed for a mobile device and rated as less difficult.

At (508) the computerized CAPTCHA system can provide the selected challenge to the user computing device. At (510) the computerized CAPTCHA system can receive a user response to the CAPTCHA challenge.

At (512) the computerized CAPTCHA system can determine whether the response received at (510) satisfactorily solves the challenge provided at (508). If it is determined at (512) that the response is not satisfactory, then at (514) the computerized CAPTCHA system can deny verification of the user computing device. Alternatively, if the response is not satisfactory, then at (514) the computerized CAPTCHA system can provide an additional challenge or perform other operations to further attempt to verify the user computing device.

Further, at (514) the computerized CAPTCHA system can optionally notify the resource provider that the user computing device has failed the verification process.

However, if it is determined at (512) that the response is satisfactory, then method (500) can proceed to (516) of FIG. 5B. Referring now to FIG. 5B, at (516) the computerized CAPTCHA system can generate a verification token and provide it to the user computing device.

At (518) the computerized CAPTCHA system can receive the verification token from the resource provider. For example, the auction website can have received the verification token from the user's smartphone and then provided to the computerized CAPTCHA system for validation. Further, in some implementations, at (518) the resource provider can also provide a private key to identify itself to the computerized CAPTCHA system.

At (520) it can be determined whether the verification token received at (518) is valid. If it is determined at (520) that the verification token has expired, been modified, or is otherwise invalid, then method (500) can proceed to (522) and inform the resource provider that the verification token is invalid.

However, if it is determined at (520) that the verification token is valid, then method (500) can proceed to (524) and provide a validation of the verification token to the resource provider.

In such fashion, the user and/or her smartphone can be verified to the auction website by engaging in a verification process directly with the computerized CAPTCHA system. Therefore, problems associated with implementation of the verification process by the auction website can be reduced or eliminated. As an example, the auction website is not required to support multiple challenge formats or update their system each time the verification process is updated or improved. Instead, the auction website can simply rely upon the computerized CAPTCHA system to perform the entirety of the verification process and validate the resulting verification token provided by the smartphone.

While the present subject matter has been described in detail with respect to specific example embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computerized CAPTCHA system configured to perform operations, the operations comprising:
receiving, by one or more computing devices, a request from a user computing device to engage in a verification process, wherein the request is received independent of a resource provider from which the user computing device has requested a resource;
providing, by the one or more computing devices, a challenge to the user computing device at least in part in response to the request for engagement in the verification process;
receiving, by the one or more computing devices, a response to the challenge from the user computing device;
determining, by the one or more computing devices, whether the user computing device should be verified based at least in part on the response;
when it is determined that the user computing device should be verified, providing, by the one or more computing devices, a verification token to the user computing device but not the resource provider, wherein the verification token indicates that the user computing device has been verified as having a human operator;
receiving, by the one or more computing devices, a request from the resource provider to validate the verification token, wherein the resource provider received the verification token from the user computing device; and
when the verification token is valid, providing, by the one or more computing devices, a validation of the verification token to the resource provider.

2. The computerized CAPTCHA system of claim 1, wherein:
providing, by the one or more computing devices, the challenge to the user computing device comprises providing, by the one or more computing devices, the challenge directly to the user computing device; and
receiving, by the one or more computing devices, the response to the challenge from the user computing device comprises receiving, by the one or more computing devices, the response to the challenge directly from the user computing device.

3. The computerized CAPTCHA system of claim 1, wherein the request occurs as a result of a browser of the user computing device being redirected by the resource provider.

4. The computerized CAPTCHA system of claim 1, wherein the request occurs via an inline frame included in a website associated with the resource provider.

5. The computerized CAPTCHA system of claim 1, wherein the request is formatted according to an application programming interface associated with the computerized CAPTCHA system.

6. The computerized CAPTCHA system of claim 1, wherein the computerized CAPTCHA system is configured to perform further operations prior to providing the challenge to the user computing device, the further operations comprising:
obtaining, by the one or more computing devices, data describing one or more characteristics associated with the user computing device based at least in part on the request; and
selecting, by the one or more computing devices, the challenge based on the one or more characteristics associated with the user computing device.

7. The computerized CAPTCHA system of claim 6, wherein the data describing the one or more characteristics comprises data identifying a user account associated with the user computing device.

8. The computerized CAPTCHA system of claim 6, wherein the data describing the one or more characteristics associated with the user computing device comprises data describing one or more computing capabilities supported by the user computing device.

9. The computerized CAPTCHA system of claim 8, wherein selecting, by the one or more computing devices, the challenge provided to the user computing device based on the one or more characteristics associated with the user computing device comprises selecting a challenge programming language based on the one or more computing capabilities.

10. The computerized CAPTCHA system of claim 6, wherein selecting, by the one or more computing devices, the challenge provided to the user computing device based on the one or more characteristics associated with the user computing device comprises selecting a challenge format based on the one or more characteristics associated with the user computing device.

11. The computerized CAPTCHA system of claim 6, wherein selecting, by the one or more computing devices, the challenge provided to the user computing device based on the one or more characteristics associated with the user computing device comprises selecting one or more of a challenge shape or a challenge size based on the one or more characteristics associated with the user computing device.

12. The computerized CAPTCHA system of claim 6, wherein:
the data describing the one or more characteristics associated with the user computing device comprises data indicating that the user computing device comprises a mobile device; and
selecting, by the one or more computing devices, the challenge provided to the user computing device based on the one or more characteristics associated with the user computing device comprises selecting a CAPTCHA challenge designed for mobile devices.

13. (canceled)

14. A user computing device configured to perform operations, the operations comprising:
requesting, by the user computing device, access to a resource from a resource provider;
requesting, by the user computing device, to engage in a verification process with a computerized CAPTCHA system, wherein the verification process occurs independent of the resource provider;
receiving, by the user computing device, a verification token from the computerized CAPTCHA system as a result of successfully completing the verification process, wherein the verification token indicates that the user computing device has been verified as having a human operator;
providing, by the user computing device, the verification token to the resource provider for the resource provider to provide to the computerized CAPTCHA system for validation; and
after the resource provider has received validation of the verification token from the computerized CAPTCHA system, receiving, by the user computing device, access to the resource from the resource provider.

15. The user computing device of claim 14, wherein requesting, by the user computing device, to engage in a verification process with a computerized CAPTCHA system comprises directly connecting, by the user computing device, to the computerized CAPTCHA system and transmitting, by the user computing device, the request to engage in the verification process directly to the computerized CAPTCHA system.

16. The user computing device of claim 14, wherein requesting, by the user computing device, to engage in the verification process with the computerized CAPTCHA system comprises receiving computer-readable code from the resource provider as a result of requesting access to the resource, wherein the computer-readable code instructs the user computing device to directly connect to the computerized CAPTCHA system and request to engage in the verification process.

17. The user computing device of claim 14, wherein requesting, by the user computing device, to engage in the verification process with the computerized CAPTCHA system comprises executing a user computing-side script provided to the user computing device via an object embedded in a website associated with the resource provider.

18. A computer-implemented method for verifying a resource requesting entity, the computer-implemented method comprising:
performing, by one or more computing devices, a verification process with the resource requesting entity independent of a resource provider, wherein the verification process comprises:
providing, by the one or more computing devices, a CAPTCHA challenge to the resource requesting entity;
receiving, by the one or more computing devices, a CAPTCHA response from the resource requesting entity; and
when the CAPTCHA response satisfies the CAPTCHA challenge, providing, by the one or more computing devices, a verification token to the resource requesting entity but not to the resource provider, wherein the verification token verifies that the resource requesting entity has a human operator;
receiving, by the one or more computing devices, a request from the resource provider to validate the verification token, wherein the resource provider received the verification token from the resource requesting entity; and
when the verification token is valid, providing, by the one or more computing devices, a validation of the verification token to the resource provider.

19. The computer-implemented method of claim 18, wherein the verification process further comprises, prior to providing the CAPTCHA challenge, receiving, by the one or more computing devices, a request to engage in the verification process directly from the resource requesting entity.

20. The computer-implemented method of claim 19, wherein the verification process further comprises, prior to providing the CAPTCHA challenge:
identifying, by the one or more computing devices, one or more constraints associated with the resource requesting entity, wherein the one or more constraints comprise one or more of a display size, a computing capability, or whether the resource requesting entity comprises a mobile device; and
selecting, by the one or more computing devices, the CAPTCHA challenge based at least in part on the one or more constraints.

21. The computerized CAPTCHA system of claim 8, wherein selecting, by the one or more computing devices, the challenge provided to the user computing device based on the one or more characteristics associated with the user computing device comprises:
determining, by the one or more computing devices, whether the user computing device includes a touch-sensitive input device;
when it is determined that the user computing device includes the touch-sensitive input device, selecting, by the one or more computing devices, a challenge that requires utilization of the touch-sensitive input device to respond to the challenge; and
when it is determined that the user computing device does not include the touch-sensitive input device, selecting, by the one or more computing devices, a challenge that does not require utilization of the touch-sensitive input device to respond to the challenge.
